(19) United States
(12) Patent Application Publication
(10) Pub. No.: US 2024/0168977 A1
(43) Pub. Date: May 23, 2024

(54) DRIVER ESTIMATION DEVICE

(71) Applicant: TOYOTA JIDOSHA KABUSHIKI KAISHA, Toyota-shi (JP)

(72) Inventor: Keiji KISHIDA, Toyoake-shi (JP)

(73) Assignee: TOYOTA JIDOSHA KABUSHIKI KAISHA, Toyota-shi (JP)

(21) Appl. No.: 18/467,109

(22) Filed: Sep. 14, 2023

(30) Foreign Application Priority Data
Nov. 22, 2022 (JP) 2022-186678

(51) Int. Cl. G06F 16/28; G06F 11/30; G06F 11/34

(52) U.S. Cl. CPC G06F 16/285; G06F 11/3013; G06F 11/3438

(57) ABSTRACT

The driver estimation device includes: a collection unit that collects a plurality of pieces of time series driving data of a vehicle in units from one start point to one end point; a calculation unit that calculates a degree of deviation between a plurality of elements each included in a corresponding one of the pieces of time series driving data and each indicating a location; and a labeling unit that attaches a driver label to each of the pieces of time series driving data by clustering the pieces of time series driving data based on the degree of deviation.

### CROSS-REFERENCE TO RELATED APPLICATION

This application claims priority to Japanese Patent Application No. 2022-186678 filed on Nov. 22, 2022, incorporated herein by reference in its entirety.

### BACKGROUND

### 1. Technical Field

The present disclosure relates to the technical field of driver estimation devices.

### 2. Description of Related Art

For example, a device for estimating a driver from the degree of correlation between personal characteristics and driving vehicle signals has been proposed as this type of device (see Japanese Unexamined Patent Application Publication No. 2019-016238 (JP 2019-016238 A)). This device collects and analyzes the driving vehicle signals only for road sections where it is easy to identify the personal characteristics.

### SUMMARY

In the technique described in JP 2019-016238 A, an estimation model for acquiring the degree of correlation between personal characteristics and driving vehicle signals is generated by machine learning using training data. The machine learning using training data is so-called supervised learning. When the training data cannot be used, it may be difficult to estimate a driver with the technique described in JP 2019-016238 A.

The present disclosure was made in view of the above problem, and it is an object of the present disclosure to provide a driver estimation device that can appropriately estimate a driver even when training data cannot be used.

A driver estimation device according to an aspect of the present disclosure includes: a collection unit configured to collect a plurality of pieces of time series driving data of a vehicle in units of one start point to one end point; a calculation unit configured to calculate a degree of deviation between a plurality of elements each included in a corresponding one of the pieces of time series driving data and each indicating a location; and a labeling unit configured to attach a driver label to each of the pieces of time series driving data by clustering the pieces of time series driving data based on the degree of deviation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a server device according to an embodiment;

FIG. 2 is a diagram illustrating an example of time series driving data;

FIG. 3 is a diagram illustrating an example of locations included in the time series driving data; and

FIG. 4 is a diagram illustrating an example of a change in vehicle speed near an exit of an expressway.

### DETAILED DESCRIPTION OF EMBODIMENTS

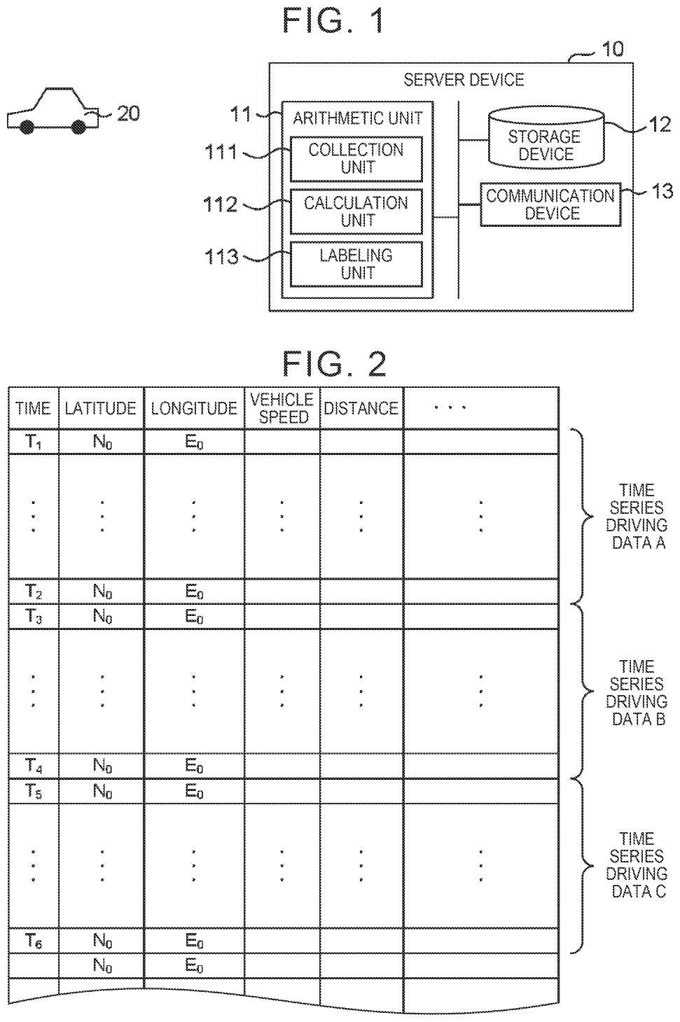

An embodiment of a driver estimation device will be described with reference to FIGS. 1 to 4. Here, the server device 10 is exemplified as an example of the driver estimation device.

In FIG. 1, the server device 10 includes an arithmetic device 11, a storage device 12, and a communication device 13. The arithmetic device 11 includes a collection unit 111, a calculation unit 112, and a labeling unit 113. The collection unit 111, the calculation unit 112, and the labeling unit 113 may be logically implemented processing blocks. The collection unit 111, the calculation unit 112, and the labeling unit 113 may be physically implemented processing circuits. The server device 10 can communicate with the vehicle 20 via the communication device 13. That is, the vehicle 20 is a so-called connected car.

The vehicle 20 includes a location sensor and a vehicle speed sensor. The location sensor may detect the location of the vehicles 20 using, for example, Global Positioning System (GPS). The vehicle 20 records the location of the vehicle 20 detected by the location sensor, the vehicle speed detected by the vehicle speed sensor, the travel distance calculated based on the detected vehicle speed, and the like at a predetermined cycle (for example, several seconds to several tens of seconds). As a result, time series driving data is generated. The vehicle 20 sends the time series driving data to the server device 10 at a predetermined timing.

The vehicle 20 is a vehicle that departs from the delivery center, travels through a plurality of stores, and then returns to the delivery center. After leaving the delivery center, the driver does not change until returning to the delivery center. Further, as long as it is possible to visit a plurality of stores, the driver can arbitrarily determine a route on which the vehicle 20 travels after departing from the delivery center and before returning to the delivery center.

FIG. 2 shows an example of the time series driving data generated by the vehicle 20. In FIG. 2, the latitude N₀ and longitude E₀ indicate the location of the delivery center. As described above, the vehicle 20 departs from the delivery center, travels through a plurality of stores, and then returns to the delivery center. Therefore, the time series driving data A from time T₁ to time T₂ is time series driving data when a first driver drove the vehicle 20. The time series driving data B from time T₃ to time T₄ is time series driving data when a second driver drove the vehicle 20. The second driver may be different from the first driver. The second driver may be the same as the first driver. The time series driving data C from time T₅ to time T₆ is time series driving data when a third driver drove the vehicle 20. The third driver may be different from the first driver and the second driver. The third driver may be the same as the first driver or the second driver.

The collection unit 111 of the server device 10 collects the time series driving data from the vehicle 20. At this time, the collection unit 111 collects time series driving data in units from a delivery center as a start point to the delivery center as an end point. In the case of the time series driving data shown in FIG. 2, the collection unit 111 collects a plurality of pieces of time series driving data including time series driving data A, time series driving data B, and time series driving data C. The collection unit 111 stores the pieces of time series driving data in the storage device 12.

The characteristics of the driver are reflected in the time series driving data. When the driver returns to the delivery center after departing the delivery center and traveling through a plurality of stores, if the driver is the same, the location (i.e., the travel route) and speed of the vehicle 20 are similar even between different pieces of time series driving data. On the other hand, if the driver is different, either or both of the location and speed of the vehicle 20 may deviate relatively greatly. The server device 10 clusters the pieces of time series driving data based on an element in which a difference appears for each driver.

In the present embodiment, the following (i) to (v) are exemplified as the above-described elements. (i) The location of the vehicle 20 (that is, the travel route). (ii) A change in vehicle speed near the exit of an expressway interchange. (iii) The location where the vehicle 20 had been stopped for a predetermined period of time or more and that is different from the locations of the stores. (iv) When the vehicle 20 is a refrigerator vehicle, the location where the refrigeration function was turned off. (v) When the vehicle 20 is a fuel cell electric vehicle, the location where water generated during power generation is drained by an operation performed by the driver.

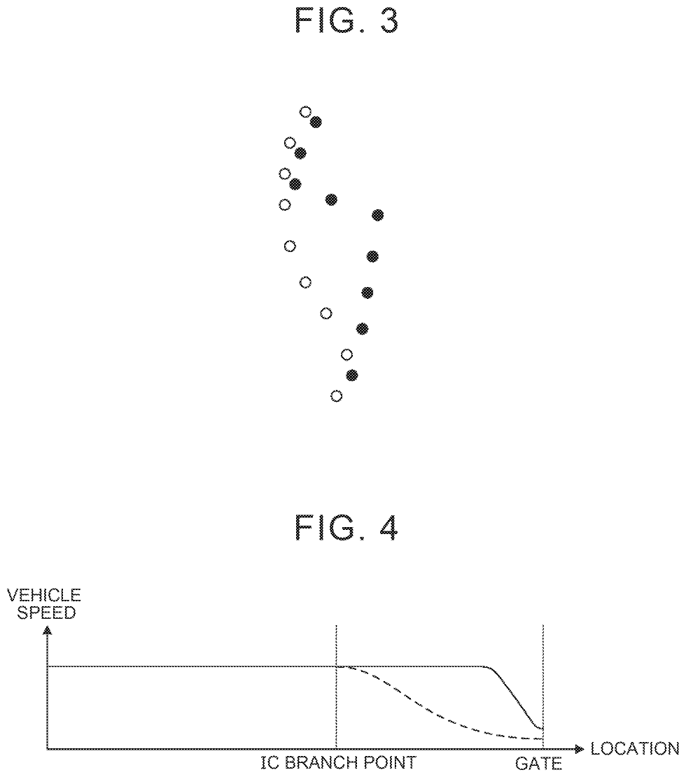

The plurality of drivers includes a driver who selects the same travel route each time, and a driver who changes the travel route according to the road condition. Such drivers can be clustered by comparing the locations of the vehicle 20 between the pieces of time series driving data. FIG. 3 shows a plurality of locations included in each of two pieces of time series driving data. In FIG. 3, white circles indicate a plurality of locations included in one time series driving data. In FIG. 3, black circles indicate a plurality of locations included in the other time series driving data. The calculation unit 112 of the server device 10 calculates the degree of deviation between one white circle and one black circle closest to the one white circle. The degree of deviation may be expressed as a vector distance. The calculation unit 112 calculates a plurality of degrees of deviation for a plurality of locations included in one piece of time series driving data (corresponding to white circles in FIG. 3) and a plurality of locations included in another piece of time series driving data (corresponding to black circles in FIG. 3). The calculation unit 112 performs the above process on all of the pieces of time series driving data in a brute force manner. The labeling unit 113 of the server device 10 may cluster the pieces of time series driving data based on the plurality of degrees of deviation calculated by the calculation unit 112.

The driver's driving characteristics are likely to appear near the exit of the interchange on the expressway. FIG. 4 is a diagram illustrating an example of a change in vehicle speed. In FIG. 4, an “IC branch point” means a branch point between a main line of an expressway and a communication path connecting the expressway and the ordinary road. In FIG. 4. “gate” means an exit gate (e.g., a toll collection facility) of an expressway. The plurality of drivers include a driver (see a solid line in FIG. 4) who travels at a relatively high vehicle speed even after entering the communication path and rapidly decelerates near the exit gate. Further, the plurality of drivers include a driver (refer to a broken line in FIG. 4) who enters the communication path and then slowly decelerates to approach the exit gate.

10 The labeling unit 113 may extract the vehicle speed corresponding to near the exit of the interchange on the expressway based on the locations included in each of the pieces of time series driving data. The labeling unit 113 may cluster the pieces of time series driving data based on the extracted change in vehicle speed.

In a case where a plurality of stores is visited, the arrival time to each store is often designated. On the other hand, depending on the road conditions, it may arrive at the store much earlier than the designated time. In such a case, the driver of the vehicle 20 may stop for time adjustment at a different place (i.e., location) from the stores. Then, the place to adjust the time is often different for each driver. The labeling unit 113 may cluster the pieces of time series driving data based on a location where the vehicle 20 had been stopped for a predetermined period of time or more and that is different from the locations of the stores.

When a plurality of stores is visited, the vehicle 20 becomes an empty load after arriving at the last store. When the vehicle 20 is a refrigeration vehicle, the plurality of drivers include a driver who turns off the refrigeration function before departing from the last store and a driver who does not turn off the refrigeration function. The labeling unit 113 may cluster the pieces of time series driving data based on the location where the refrigeration function was turned off.

When the vehicles 20 are fuel cell electric vehicle, water generated during power generation can be drained by an operation performed by the driver. When the driver drains the water generated during power generation, the personality of the driver appears at the discharge place. The labeling unit 113 may cluster the pieces of time series driving data based on the location where water generated during power generation was drained by an operation performed by the driver.

The labeling unit 113 may cluster the pieces of time series driving data based on at least one of the following (i) to (v). (i) The location of the vehicle 20 (specifically, the degree of deviation calculated by the calculation unit 112). (ii) A change in vehicle speed near the exit of an expressway interchange. (iii) The location where the vehicle 20 had been stopped for a predetermined period of time or longer and that is different from the locations of the stores. (iv) When the vehicle 20 is a refrigerator vehicle, the location where the refrigeration function was turned off. (v) When the vehicle 20 is a fuel cell electric vehicle, the location where water generated during power generation was drained by an operation performed by the driver. The labeling unit 113 attaches a driver label indicating a driver to each of the pieces of time series driving data based on the clustering result. That is, the labeling unit 113 estimates the drivers corresponding to each of the pieces of time series driving data.

### Technical Effects

When a plurality of drivers use one vehicle (e.g., vehicle 20), the driver cannot be identified based on vehicle information (e.g., vehicle ID). Therefore, a driver label indicating the driver cannot be attached to the time series driving data. Therefore, in this case, it is not possible to construct a predictor for estimating the driver by supervised learning using training data. In the present embodiment, attention has been paid to the fact that the driver does not change after the vehicle 20 departs from the delivery center until returning to the delivery center. In the present embodiment, the collection unit 111 collects time series driving data in units from the delivery center as a start point to the delivery center as an end point. Then, the labeling unit 113 estimates the driver of each of the pieces of time series driving data by clustering the pieces of time series driving data collected by the collection unit 11. Therefore, in the present embodiment, it is possible to estimate the driver without requiring supervised learning, in other words, to give a driver label indicating the driver. Therefore, according to the present embodiment, the driver can be appropriately estimated even when training data cannot be used.

An aspect of the disclosure derived from the above embodiment will be described below.

A driver estimation device according to an aspect of the disclosure includes: a collection unit that collects a plurality of pieces of time series driving data of a vehicle in units from one start point to one end point; a calculation unit that calculates a degree of deviation between a plurality of elements each included in a corresponding one of the pieces of time series driving data and each indicating a location; and a labeling unit that attaches a driver label to each of the pieces of time series driving data by clustering the pieces of time series driving data based on the degree of deviation. In the above embodiment, the “collection unit 111” corresponds to an example of the “collection unit”, the “calculation unit 112” corresponds to an example of the “calculation unit”, and the “labeling unit 113” corresponds to an example of the “labeling unit.”

The pieces of time series driving data may include a vehicle speed near an exit of an expressway. The labeling unit may cluster the pieces of time series driving data based on a change in the vehicle speed near the exit of the expressway in addition to the degree of deviation.

The pieces of time series driving data may include a location where the vehicle was stopped. The labeling unit may cluster the pieces of time series driving data based on a location where the vehicle had been stopped for a predetermined period of time or more, in addition to the degree of deviation.

The vehicle may comprise refrigeration equipment. The pieces of time series driving data may include a location where a refrigeration function of the refrigeration equipment was turned off. The labeling unit may cluster the pieces of time series driving data based on the location where the refrigeration function was turned off, in addition to the degree of deviation.

The vehicles may be fuel cell electric vehicle. The pieces of time series

driving data may include a location where water generated during power generation was drained by an operation performed by a driver. The labeling unit may cluster the pieces of time series driving data based on the location where the water generated during power generation was drained by the operation performed by the driver, in addition to the degree of deviation.

The present disclosure is not limited to the above-described embodiments, and can be modified as appropriate within the scope and spirit of the disclosure that can be read from the claims and the specification as a whole, and a driver estimation device accompanied by such a change is also included in the technical scope of the present disclosure.

What is claimed is:

1. A driver estimation device, comprising:
a collection unit configured to collect a plurality of pieces of time series driving data of a vehicle in units of one start point to one end point;
a calculation unit configured to calculate a degree of deviation between a plurality of elements each included in a corresponding one of the pieces of time series driving data and each indicating a location; and
a labeling unit configured to attach a driver label to each of the pieces of time series driving data by clustering the pieces of time series driving data based on the degree of deviation.

2. The driver estimation device according to claim 1, wherein
the pieces of time series driving data include a vehicle speed near an exit of an expressway, and
the labeling unit is configured to cluster the pieces of time series driving data based on a change in the vehicle speed near the exit of the expressway, in addition to the degree of deviation.

3. The driver estimation device according to claim 1, wherein
the pieces of time series driving data include a location where the vehicle was stopped, and
the labeling unit is configured to cluster the pieces of time series driving data based on a location where the vehicle had been stopped for a predetermined period of time or more, in addition to the degree of deviation.

4. The driver estimation device according to claim 1, wherein
the vehicle includes refrigeration equipment,
the pieces of time series driving data include a location where a refrigeration function of the refrigeration equipment was turned off, and
the labeling unit is configured to cluster the pieces of time series driving data based on the location where the refrigeration function was turned off, in addition to the degree of deviation.

5. The driver estimation device according to claim 1, wherein
the vehicle is a fuel cell electric vehicle,
the pieces of time series driving data include a location where water generated during power generation was drained by an operation performed by a driver, and
the labeling unit is configured to cluster the pieces of time series driving data based on the location where the water generated during power generation was drained by the operation performed by the driver, in addition to the degree of deviation.
